(19) United States
(12) Patent Application Publication
(10) Pub. No.: US 2008/0063253 A1
(43) Pub. Date: Mar. 13, 2008

(54) SLEEVE FOR CAPTURING CHECK IMAGES

(76) Inventor: Daniel J. Wood, Las Vegas, NV (US)

Correspondence Address: LAW OFFICE OF RAY R. REGAN, P.A., P.O. BOX 1442, CORRALES, NM, 87048, US

(21) Appl. No.: 11/847,966

(22) Filed: Aug. 30, 2007

Related U.S. Application Data
(63) Continuation-in-part of application No. 11/736,625, filed on Apr. 18, 2007.
Application No. 11/736,625 is a continuation-in-part of application No. 11/492,453, filed on Jul. 25, 2006.

(51) Int. Cl. G06K 9/00

(52) U.S. Cl. 382/137

(57) ABSTRACT

The specification and drawing figures describe and show a sleeve for capturing check images that is formed from a sheet of anti-static image transferable material. A plurality of leaves are cut or formed from the anti-static image transferable material. Using an adhesive, the leaves are assembled into a sleeve having an opening to accommodate insertion of a check. A correction strip is attached adjacent at least one longitudinal edge of the sleeve on which information may be printed or imprinted. The sleeve is processed through an imaging machine for reading and recording the image of the check and any information added to the check and/or the sleeve.

### CROSS-REFERENCE TO RELATED APPLICATION

This application is a continuation-in-part of U.S. application Ser. No. 11/736,625 filed on Apr. 18, 2007 entitled COATED CARRIER FOR CAPTURING IMAGES FROM A CHECK, that itself is a continuation-in-part of U.S. application Ser. No. 11/492,453 filed on Jul. 25, 2006 entitled CARRIER FOR CAPTURING DIGITAL IMAGES FROM A CHECK (the parent application), the contents of which are incorporated into this document by reference (collectively, the “pending applications”).

### FIELD OF TECHNOLOGY

The apparatus and method disclosed, illustrated, and claimed in this document pertain generally to enabling an imaging machine to capture images from a sleeve and the contents of a sleeve that passes through the imaging machine. More particularly, the new and useful sleeve that allows images to be captured during processing from one or both sides of a check as well as from additional information printed and imprinted on the sleeve, is advantageous for processing a damaged check and portions of a damaged check through imaging machines. The sleeve is particularly, but not exclusively, useful for meeting and exceeding standards and criteria established by the Check Clearing for the 21st Century Act.

While the apparatus and method disclosed and claimed in the pending applications have proven useful for the intended applications described in those documents, additional contributions to the art as disclosed, illustrated, and claimed in this document provide optimizations and embodiments in which the principles of operation and differing configurations result in additional advantages.

### BACKGROUND

Banks and other financial institutions process approximately 50 billion checks annually. About two percent of those checks are damaged, and approximately another two percent are returned to a bank of first deposit because an account has insufficient funds. Accordingly, processing checks to numerous banks on data processing machines and imaging machines, and complying with the Check Clearing for the 21st Century Act signed into law on Oct. 23, 2003, effective on Oct. 28, 2004, present a number of challenges not currently satisfied by all check carriers.

Check carriers have been used in various forms for at least forty years to handle and process not only undamaged but also damaged and mutilated items through imaging machines, and to correct magnetic code lines printed generally along the bottom of a check. Carriers are used because high-speed check readers and sorters may further damage or mutilate damaged checks unprotected by a carrier.

Accredited Standards Committee X9 has provided specifications for both documents and carriers. Patents have issued in connection with carriers that accompany checks through data processing machinery. Exemplary carriers are described and claimed in U.S. Pat. No. 3,576,972 to Daniel J. Wood, the inventor named in this document, U.S. Pat. No. 3,702,924 to Daniel J. Wood, et al.; U.S. Pat. No. 4,927,071 to Daniel J. Wood, U.S. Pat. No. 5,419,588 to Daniel J. Wood, and in the pending applications described in this document.

Advances in the technology associated with image capturing machines, and heightened concerns in the United States since the events of Sep. 11, 2001 that disclosed a need to process checks despite interruptions due to man-made and natural catastrophes, have created a need for new carriers, pouches and sleeves for processing checks, including damaged checks. The Check Clearing for the 21st Century Act (referred to in the industry as “Check 21”) is designed to foster innovation in the payments system and to enhance efficiencies by reducing legal impediments to check truncation. The Act facilitates check truncation by creating a new negotiable instrument called a “substitute check” which enables banks to truncate original checks, to process check information electronically, and to deliver substitute checks to banks that desire to continue receiving paper checks. Under the Act, a substitute check is deemed the legal equivalent of an original check and includes all information contained on an original check.

Instead of physically moving paper checks from one bank to another, Check 21 allows banking institutions (“banks”) to process checks electronically. Banks may capture an image of the front and/or back of a check, along with payment information, identifying information, and/or additional information desired by a bank and/or required by law, and to transmit the captured information electronically. If a receiving bank or its customer requires a paper check, the bank may use the electronic image and payment information to create a paper “substitute check.” This process enables banks to reduce the cost of physically processing, handling and transporting original paper checks, a very expensive procedure.

The apparatus and methods disclosed and claimed in this document achieve the goals of Check 21 and the financial and banking industry by providing a sleeve capable of allowing a data processing machine, a document processing machine, a image capturing machine, an image-enabled reader, an image-enabled sorter, an automatic magnetic character recognition sorting machine, or similar imaging machine (collectively in this document, “imaging machine”) to obtain or capture desired and/or necessary images of data and information associated with a check, substitute check, or similar document.

To meet not only the legal developments, but also the ever-increasing speed of imaging machines, a sleeve for capturing check images and check-related images is needed. The sleeve disclosed and claimed in this document is capable of processing both damaged and undamaged checks through conventional currently available imaging machines.

Earlier carriers did not always provide a means for capturing a clear, accurate image of the front and back of the document during passage of the carrier through modern imaging machines. Some carriers use solid color paper or a waxy paper that may distort a clear image of the document. Some carrier sheets do not lay flat against the check, preventing a clear image of the check. Different positions of a check relative to a carrier might alter the focus of the image as a check in a sleeve is processed past a camera or other device for capturing images.

In addition, the size and construction of some carriers increased the difficulty of placing an unconventional large-sized check or document in a carrier without folding them, another problem solved by the carrier disclosed, shown and claimed in the earlier pending applications and in this document. European checks, for example, may be considerably larger than conventional United States checks. As will be evident to one skilled in the art, a folded check does not provide a complete view of the check. In addition, the new substitute check (sometimes referred to in the industry as an “IRD”) may not fit into some carriers. Some carriers are constructed so that a check is not secure within the carrier as it passed through data processing equipment, causing movement within the carrier that distorted an image obtained of the check.

### SUMMARY

Many challenges posed by the Check Clearing Act and caused by changes in imaging machines through which checks are processed were addressed and solved by the apparatus and methods disclosed, shown and claimed in the pending prior applications as shown in FIGS. 1A through 6B, and in the pending applications described in this document. This document and the sleeve illustrated in FIGS. 7A-7C add to the art and advance the technology as described, illustrated and claimed in this document. For example, the sleeve disclosed, shown and claimed in this document is less expensive to produce, more quickly manufactured, and may be more quickly and simply used by an end-user. The sleeve disclosed, shown and claimed in this document minimizes mistakes, both human and machine-induced, that may occur during a check imaging process.

The representation-passable coating that may be applied to the outer surface of at least a leaf of the sleeve identified in this document as the “back leaf” permits application, printing, and imprinting (collectively, “printing”) of endorsements and other information on the back leaf that may be read and imaged by an imaging machine as the sleeve passes through the imaging machine.

In addition, attaching a correction strip adjacent the lower longitudinal edge of at least the leaf of the sleeve identified in this document as the “front leaf” enables printing of encoding, such as MICR codes, and other information on the correction strip that may be read and imaged by the imaging machine as the sleeve passes through the imaging machine. The term “MICR” is an acronym for Magnetic Ink Character Recognition, which describes a procedure for printing codes along one edge of a document or a band in magnetic ink. The code line is divided into fields that inform banks and other institutions about the amount of the check, account numbers, and other data.

Also, the sleeve disclosed, shown and claimed in this document provides for use of an appropriate adhesive, as defined in this document, to connect the leaves formed from the image transferable material to form a pouch into which a check may be placed for processing through an imaging machine to securely hold a damaged or undamaged check in place during passage of the sleeve through the imaging machine. At least one technical advantage of the appropriate adhesive is its capability to fixedly connect plastic-to-plastic materials such as the opposing leaves made from an image transferable material.

The image transferable material is preferably an anti-static plastic that provides the technical advantage of avoiding material-induced and/or machine-induced “static” electricity problems that might arise during passage of the sleeve through an imaging machine. The sleeve for capturing check images disclosed and claimed in this document is capable of holding portions of a paper check in a specific place with a specific orientation relative to the sleeve that is representative of the check's actual location and orientation in the check's original undamaged form. This is achieved in part by using a material to make the sleeve that is both anti-static and image transferable; also in part by applying a coating to at least one of the outer surfaces of the sleeve formed from the image transferable material; and in part by applying an appropriate adhesive to portions of the leaves of the sleeve to form a pouch having one open end for insertion of a check as described, shown, and claimed in this document.

The apparatus disclosed and claimed in this document also keeps damaged document edges with folds or tears from jamming in an imaging machine by compressing the damaged check between a set of opposing leaves of the sleeve. The opposing leaves, made of anti-static image transferable material, contribute to keeping a check flat during processing by an imaging machine, which in turn keeps the check in focus as the check and sleeve are processed rapidly through image machines.

The sleeve for capturing check images that is disclosed, illustrated and claimed in this document achieves the advantages recited in this document by forming a sleeve from image transferable material. Preferably, the image transferable material also is anti-static. The sleeve is cut or formed into at least two substantially identically dimensioned and substantially rectangular leaves. Each leaf has an inner surface, an outer surface, opposing longitudinal edges, and opposing lateral edges. An appropriate adhesive is applied to at least one inner surface of the at least two leaves adjacent the two opposing lateral edges and adjacent one of the opposing longitudinal edges to fixedly connect the at least two leaves into the sleeve formed with an opening through which a check may be inserted into the sleeve. In addition, a representation-passable coating is applied to the outer surface of the back leaf to enable printing of endorsement information that may be read by an imaging machine. A correction strip is attached adjacent the longitudinal edge of the bottom longitudinal edge of the front leaf on which MICR and other information may be printed and read by the imaging machine.

It will become apparent to one skilled in the art that the claimed subject matter as a whole, including the structure of the apparatus, and the cooperation of the elements of the apparatus, combine to result in a number of unexpected advantages and utilities as will become apparent to those skilled in the art when read in conjunction with the following description, drawing figures, and appended claims.

The foregoing has outlined broadly the more important features of the invention to better understand the detailed description that follows, and to better understand the contributions to the art. The sleeve for capturing check images is not limited in application to the details of construction, and to the arrangements of the components, provided in the following description or drawing figures, but is capable of other embodiments, and of being practiced and carried out in various ways. The phraseology and terminology employed in this disclosure are for purpose of description, and therefore should not be regarded as limiting. As those skilled in the art will appreciate, the conception on which this disclosure is based readily may be used as a basis for designing other structures, methods, and systems. The claims, therefore, include equivalent constructions. Further, the abstract associated with this disclosure is intended neither to define the sleeve for capturing check images, which is measured by the claims, nor intended to limit the scope of the claims. The novel features of the sleeve for capturing check images are best understood from the accompanying drawing, considered in connection with the accompanying description of the drawing, in which similar reference characters refer to similar parts, and in which:

### BRIEF DESCRIPTION OF THE DRAWING

FIG. 1A of the drawing is a front side perspective view of the carrier for capturing digital images from a check of the Parent Application;

FIG. 1B is an obverse bottom side perspective view of the carrier for capturing digital images from a check of the Parent Application;

FIG. 2A is a perspective view of one embodiment of the carrier for capturing digital images from a check of the Parent Application;

FIG. 2B is an end view of the carrier for capturing digital images from a check of the Parent Application;

FIG. 3A is a perspective view of another embodiment of the carrier for capturing digital images from a check of the Parent Application;

FIG. 3B is an end view of the closed top configuration illustrated in FIG. 3A of the carrier for capturing digital images from a check of the Parent Application;

FIG. 4A of the drawing is a front side perspective view of the coated carrier for capturing images from a check as disclosed, illustrated and claimed in U.S. application Ser. No. 11/736,625 filed Apr. 18, 2007 for a COATED CARRIER FOR CAPTURING DIGITAL IMAGES FROM A CHECK (“pending application”);

FIG. 4B is an obverse bottom side perspective view of the of the coated carrier for capturing images from a check;

FIG. 5A is a perspective view of one embodiment of the coated carrier for capturing images from a check in an open top configuration;

FIG. 5B is an end view of the open top configuration illustrated in FIG. 5A;

FIG. 6A is a perspective view of another embodiment of the coated carrier for capturing images from a check in a closed top configuration;

FIG. 6B is an end view of the closed top configuration illustrated in FIG. 6A;

FIG. 7A is a perspective view of the sleeve for capturing check images;

FIG. 7B is an end view of the sleeve for capturing check images;

FIG. 7C also is an end view of the sleeve for capturing check images; and

FIG. 7D is a perspective view of the components of a sleeve partially connected.

To the extent that the numerical designations in the drawing figures include lower case letters such as “a,b” such designations include multiple references, and the letter “n” in lower case such as “a-n” is intended to express a number of repetitions of the element designated by that numerical reference and subscripts.

### DETAILED DESCRIPTION

### Definitions

As used in this document the term “appropriate adhesive” means an adhesive especially suitable for or compatible with the material used to manufacture the sleeve for capturing check images disclosed, illustrated, and claimed in this document. The adhesive is a substance tending to cause one component, such as the opposing leaves of the sleeve to adhere and/or bind to another component including, but not limited to, substances such as glue. An adhesive is “appropriate”, in the context of this document, for manufacturing the sleeve for capturing check images if capable, when applied to one or more surfaces of the leaves of the sleeve to enable imprinting check endorsement information, MICR encoding information, and any other information desired. In addition, a quality of the appropriate adhesive is that, following application to the sleeve, it substantially eliminates effects of static electricity during use of the sleeve in connection with an imaging machine during operation of the imaging machine. Accordingly, an appropriate adhesive may be a water-based adhesive, a hot melt adhesive, or any other adhesive that enables imprinting such information.

The term “item” and “check” mean a damaged or undamaged check, a document, a substitute check, and/or similar document.

The term “lateral edge” means one of two sides or edges of each of the two leaves that in part form the sleeve, are opposite or opposed to one another, and generally have a dimension less than the longitudinal edges of the two leaves. The opposing lateral edges are substantially parallel to one another.

The term “longitudinal edge” means one of two lengthwise edges of each of the two leaves that form the sleeve, are opposite or opposed to one another, and generally have a dimension greater than the lateral edges of the two leaves. The opposing longitudinal edges are substantially parallel to one another.

The term “imaging machine” means a data processing machine, a document processing machine, a digital image capturing machine, an image-enabled reader, an image-enabled sorter, and/or an automatic magnetic character recognition sorting machine, capable of capturing images concurrently from either one or both sides of a check (damaged or undamaged) and from a sleeve.

The term “image transferable” means the capacity or characteristic of the material used to make the sleeve to preserve a likeness or image of a document such as a check that may be captured or recorded by digital imaging machines. The material, therefore, may be clear, transparent, or translucent, depending on the photographic capabilities and efficiencies and photographic light receptivity of the apparatus used to make images of a check passing through the digital imaging machine within the sleeve described and claimed in this document.

The term “representation-passable coating” is used to avoid possible confusion with the term “image transferable material” and means the coating applied to the outer surfaces of the sleeve leaves as described, shown, and claimed in this document. Thus, as used in this document, the term “representation-passable coating” means a coating through which an image is transferable or passable without altering the likeness of the image to produce a representation of the image readable by digital imaging machines, and allows data and characters to be printed directly on the coated surfaces of a sleeve. The term “representation-passable coating” includes, but is not limited to, the coating disclosed and claimed in U.S. Pat. No. 4,762,766 issued Aug. 9, 1988 to Kenneth M. Melbye (“Melbye patent”). As indicated, the term “representation-passable coating” is not limited to the coating of the Melbye patent, but instead includes any coating that may be applied to a sleeve that allows an image or representation printed directly on a sleeve to be transferred through the representation-passable coating and thus also read and captured by digital imaging machines.

The term “carrier” and “sleeve” are used interchangeably in this document.

The term “endorsement” has a variety of meanings in this document which may not match precisely its meaning in the law of negotiable instruments. The term means any information that a user of the sleeve for capturing check images wants to add to the sleeve. The term is not limited to a signature of a check issuer or payee to make a check payable to another, or to an accommodation endorser. The term includes, but is not limited to, the several meanings “endorsement” has under the Uniform Commercial Code, such as endorsement in blank, special endorsement, conditional endorsement, qualified endorsement without recourse, and/or restrictive endorsement.

The term “exemplary” means serving as an example, instance, or illustration; any aspect described in this document as “exemplary” is not intended to mean preferred or advantageous over other aspects of the invention.

### Description

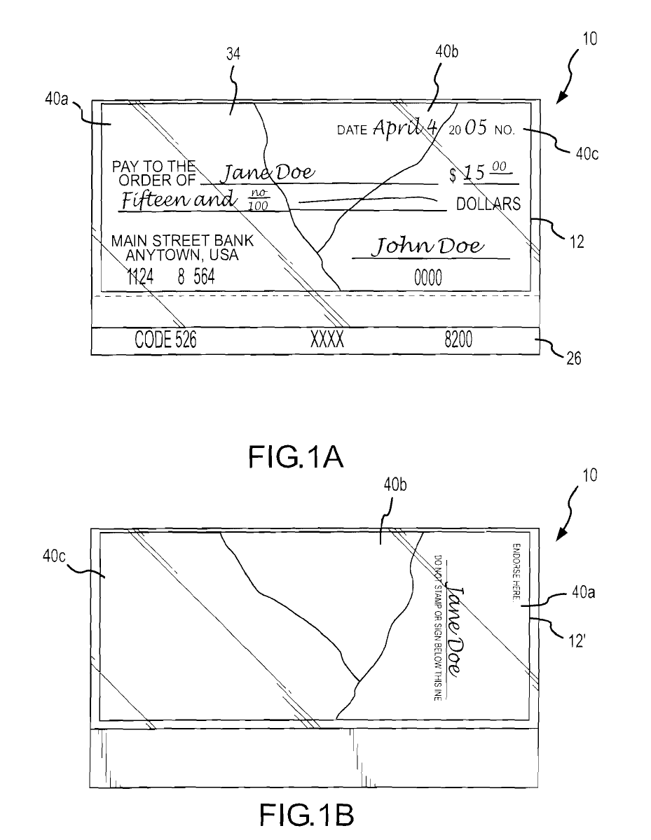

As shown in FIGS. 1A through 3B, the carrier 10 for capturing digital images concurrently from opposing sides of a check 12 is provided that in its broadest context includes a sheet of image transferable material 14.

The sheet of image transferable material 14 is formed into two leaves 16a,b. As shown, each leaf 16a,b is substantially rectangular, but the rectangular shape as shown is not a limitation of the carrier 10. The two leaves 16a,b are formed with an inner surface 18 and an outer surface 20. In addition, means 22 for bending one leaf 16a against the other leaf 16b is provided. An adhesive 24 is disposed on inner surface 18a of leaf 16a, or on inner surface 18b of leaf 16b, or on both inner surface 18a of leaf 16a and on inner surface 18b of leaf 16b for removably securing the check 12 in carrier 10.

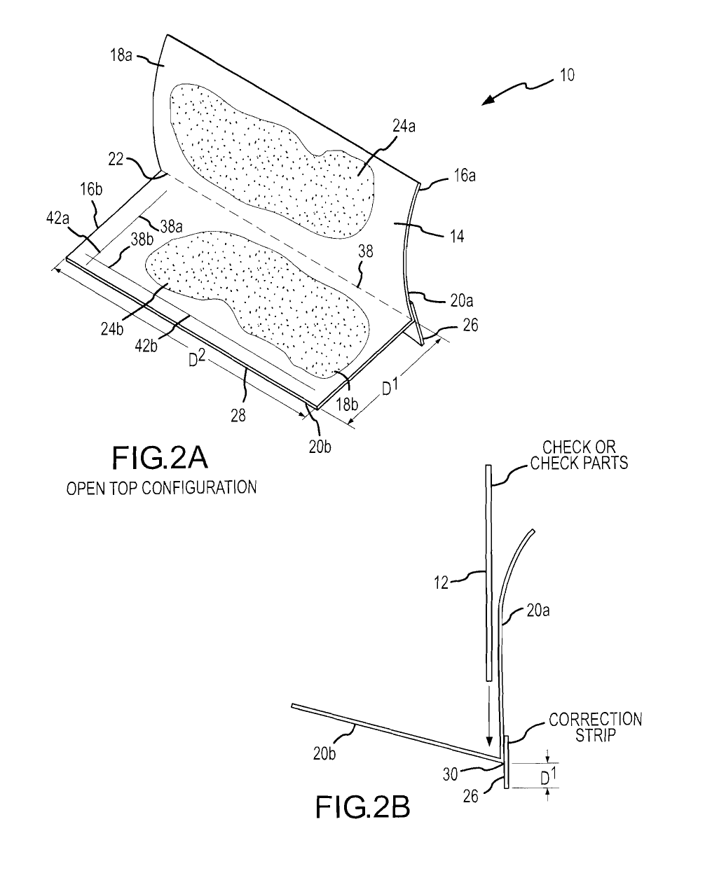

A clear band or correction strip (collectively, “correction strip”) is included. In the embodiments shown by cross-reference between FIGS. 2A-2B, illustrating carrier 10 in what the legend on FIG. 2A denotes as the “open top configuration,” the correction strip 26 is shown attached to the outer surface 20a of one leaf 16a of carrier 10. In the configuration illustrated in FIGS. 2A-2B, opposing leaves 16a,b is formed with a leading edge 28 and a trailing edge 30. Trailing edge 30 is adjacent the means for bending 22 formed in sheet of material 14 to form leaves 16a,b. As shown in FIGS. 2A and 2B, the correction strip 26 is attached to trailing edge 30 and a portion of correction strip 26, shown diagrammatically in FIG. 2B as distance D¹ extends from trailing edge 30 of carrier 10.

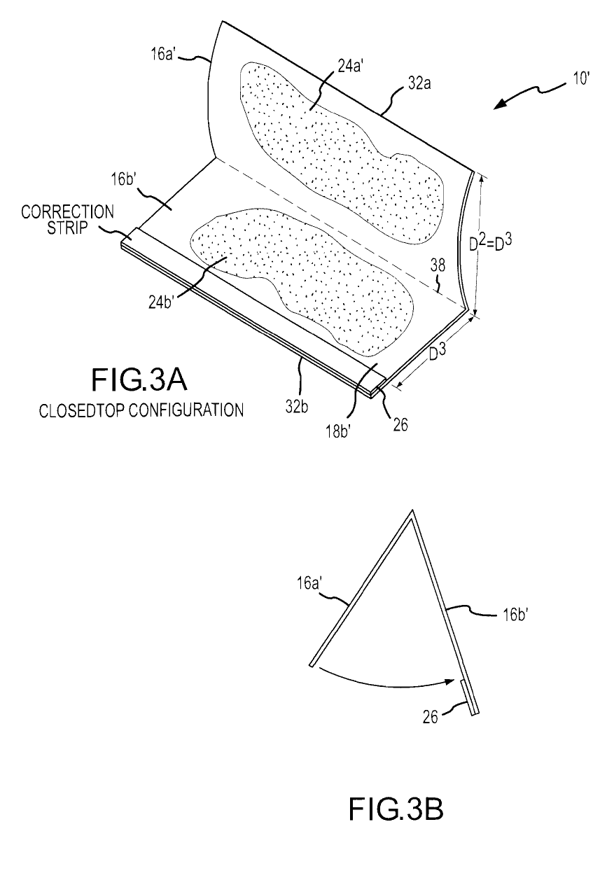

In the embodiment shown by cross-reference between FIGS. 3A-3B, illustrating carrier 10 in what the legend on FIG. 3A denotes as the “closed top configuration,” the correction strip 26 is shown attached to one leaf 16b′ of carrier 10. In the configuration illustrated in FIGS. 3A-3B, opposing leaves 16a′,b′ are formed with opposing ends 32a,b. As shown in FIGS. 3A and 3B, the correction strip 26 is attached to inner surface 18b′ adjacent opposing end 32b. As shown diagrammatically in FIG. 3A, the dimension D² of leaf 16a′ is substantially equal to dimension D³ of leaf 16b′.

The correction strip 26 is attachable to carrier 10 by use of a glue. Correction strip 26 is made of material that is receptive at least to application of MICR codes readable by a digital imaging machine.

In the embodiment shown by cross-reference between FIGS. 1A-1B, carrier 10 permits a user to reassemble and repair a damaged or mutilated check 12 and to prepare it for processing by a digital imaging machine (not shown). The digital imaging machine scans and captures images concurrently from the primary side 34 and the secondary side 36 of check 12. A digital imaging machine also has the capability to read the attached correction strip 26 containing a repaired MICR code line. The digital imaging may also have the capability of endorsing secondary side 36 of check 12 with tracking information, and to sort one or more checks 12 for storage and handling.

As shown by cross-reference between FIGS. 2A-2B, means 22 for bending leaves 16a,b toward one another is shown in FIG. 2A as a series of perforations 38. As a person skilled in the art will recognize, means 22 may also be a single scored line or other means 22. The leaves 16a,b of carrier 10 is folded over by a user. Carrier 10 arrives for use by a user in flat, unfolded sheets of image transferable material 14 that have been formed into a carrier 10 not yet bended along the means 22 for bending leaves 16a,b into carrier 10. On arrival, a user will find a thin release paper (not shown) in between one or more unfolded carriers 10. As a person skilled in the art will recognize, the thin release paper is used with many items that are pre-coated with an adhesive 24 to keep the products from sticking.

As also shown by cross-reference between FIGS. 2A-3B, adhesive 24 is shown diagrammatically. Adhesive 24 may be coated on inner surface 18a of leaf 16a, or on inner surface 18b of leaf 16b, or on both inner surface 18a,b of leaves 16a,b. A check 12, or the damaged portions 40a-c of check 12, are arranged and oriented on the adhesive 24. One or more pre-printed alignment markings 42a,b may be formed or printed on leaves 16a,b of carrier 10 to assist the user in orienting damaged portions 40a-c of check 12, or check 12, on the inner surface 18a,b of check 12.

In operation and use of carrier 10, a user lays an unfolded sheet of image transferable material 14 on a flat surface. The user removes the release paper (not shown) and places the check 12 or damaged portions 40a-c of check 12 on the inner surface 18b of leaf 16b. The user will straighten and flatten any folds or tears in the check 12. The user folds the leaf 16a along the means 22 for bending so that leaf 16a is aligned with leaf 16b. The check 12 is thereby enfolded between leaves 16a,b on the inner surfaces 18a,b of leaves 16a,b. The check 12, even if damaged, is flat and firmly held in place adjacent the alignment marks 42a,b for processing. The correction strip 26 would typically be applied as shown in FIGS. 2A-3B.

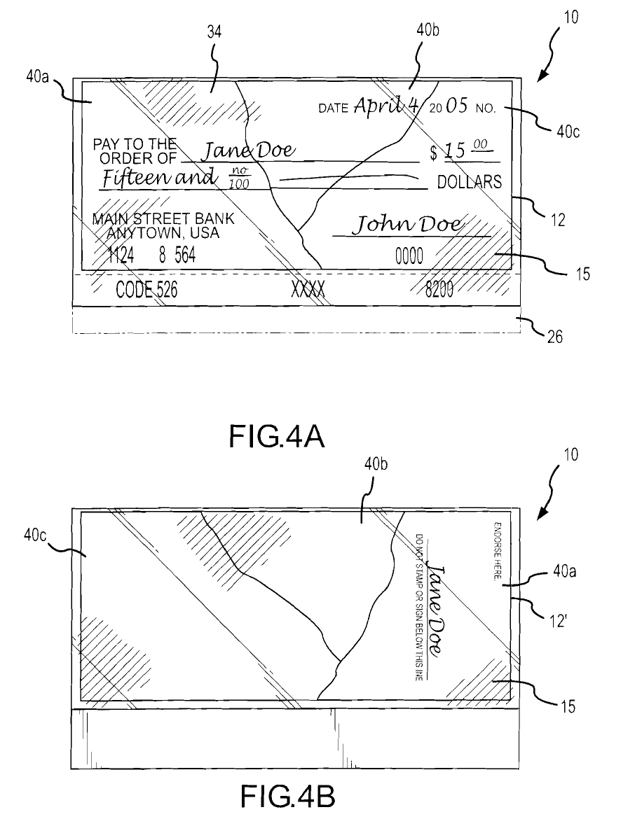

As shown in FIGS. 4A through 6B, the coated carrier 10 for capturing images from opposing sides of a check 12 is provided that in its broadest context includes a sheet of image transferable material 14.

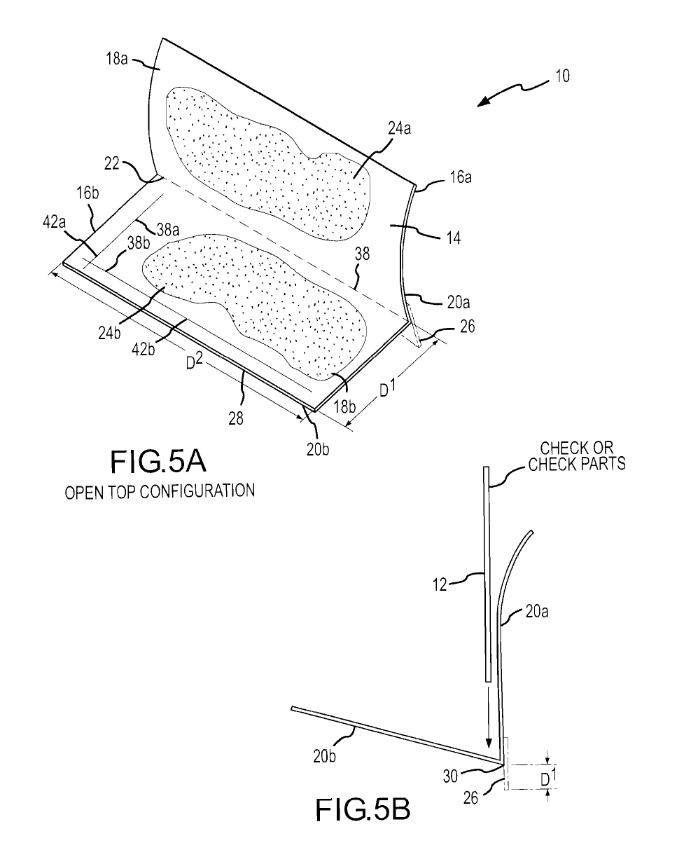

A representation-passable coating 15, shown diagrammatically in FIGS. 4A-4B, is applied to the sheet of image transferable material 14, shown best in FIG. 5A, that will be manufactured as the outer surfaces 20a,b of each of the carriers 14a-n as shown in FIG. 5B.

The sheet of image transferable material 14 is formed into two leaves 16a,b. As shown, each leaf 16a,b is substantially rectangular, but the rectangular shape as shown is not a limitation of the carrier 10. The two leaves 16a,b are formed with an inner surface 18 and, as stated, an outer surface 20a and 20b. In addition, means 22 for bending one leaf 16a against the other leaf 16b is provided. An adhesive 24 is disposed on inner surface 18a of leaf 16a, or on inner surface 18b of leaf 16b, or on both inner surface 18a of leaf 16a and on inner surface 18b of leaf 16b for removably securing the check 12 in carrier 10.

Unlike the carrier shown in the Parent Application, a clear band or correction strip (individually, a “correction strip” 26) is excluded from carrier 10, as shown diagrammatically by broken lines in FIGS. 4A and 5A-6B.

In the embodiments shown by cross-reference between FIGS. 5A-5B, illustrating carrier 10 in what the legend on FIG. 2A denotes as the “open top configuration,” because of the representation-passable coating 15 applied to outer surfaces 20a and 20b, data and information that otherwise might be applied or printed on a correction strip 26 is instead applied or printable on the outer surfaces 20a,b discussed below and shown in FIG. 4A. The representation-passable coating 15 shown in FIG. 4A permits a digital imaging machine to receive and read the data and information appearing on the outer surfaces 20a,b of carrier 10.

In the configuration illustrated in FIGS. 5A-5B, opposing leaves 16a,b are formed with a leading edge 28 and a trailing edge 30. Trailing edge 30 is adjacent the means for bending 22 formed in sheet of material 14 to form leaves 16a,b.

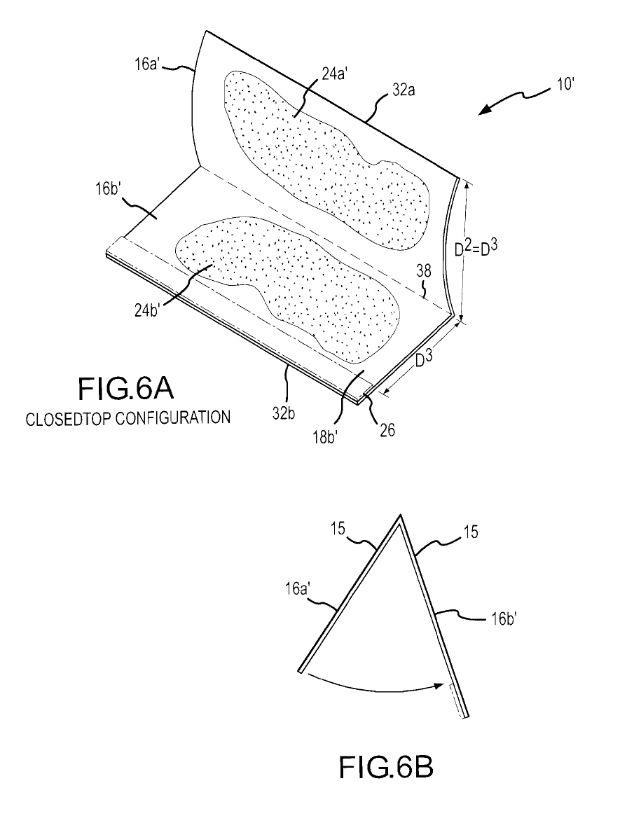

In the embodiment shown by cross-reference between FIGS. 6A-6B, illustrating carrier 10 in what the legend on FIG. 6A denotes as the “closed top configuration,” because of the representation-passable coating 15 data and information that otherwise might be applied or printed on a correction strip 26 is instead applicable to or pintable on the outer surfaces 20a,b as shown in FIG. 4A. The representation-passable coating 15 permits a digital imaging machine to receive and read the data and information appearing on the outer surfaces 20a,b of carrier 10. In the configuration illustrated in FIGS. 6A-6B, opposing leaves 16a′,b′ are formed with opposing ends 32a,b.

In the embodiment shown by cross-reference between FIGS. 6A-6B, carrier 10 permits a user to reassemble and repair a damaged or mutilated check 12 and to prepare it for processing by a digital imaging machine (not shown). The digital imaging machine scans and captures images concurrently from the primary side 34 and the secondary side 36 of check 12. A digital imaging machine also has the capability to read data and information appearing on the outer surfaces 20a,b of carrier 10, including a repaired MICR code line. The digital imaging may also have the capability of endorsing secondary side 36 of check 12 with tracking information, and to sort one or more checks 12 for storage and handling.

As shown by cross-reference between FIGS. 5A-5B, means 22 for bending leaves 16a,b toward one another is shown in FIG. 5A as a series of perforations 38. As a person skilled in the art will recognize, means 22 may also be a single scored line or other means 22. The leaves 16a,b of carrier 10 is folded over by a user. Carrier 10 arrives for use by a user in flat, unfolded sheets of image transferable material 14 that have been formed into a carrier 10 not yet bended along the means 22 for bending leaves 16a,b into carrier 10. On arrival, a user will find a thin release paper (not shown) in between one or more unfolded carriers 10. As a person skilled in the art will recognize, the thin release paper is used with many items that are pre-coated with an adhesive 24 to keep the products from sticking.

As also shown by cross-reference between FIGS. 5A-5B, adhesive 24 is shown diagrammatically. Adhesive 24 may be coated on inner surface 18a of leaf 16a, or on inner surface 18b of leaf 16b, or on both inner surface 18a,b of leaves 16a,b. A check 12, or the damaged portions 40a-c of check 12, are arranged and oriented on the adhesive 24. One or more pre-printed alignment markings 42a,b may be formed or printed on leaves 16a,b of carrier 10 to assist the user in orienting damaged portions 40a-c of check 12, or check 12, on the inner surface 18a,b of check 12.

In operation and use of carrier 10, a user lays an unfolded sheet of image transferable material 14 on a flat surface. The user removes the release paper (not shown) and places the check 12 or damaged portions 40a-c of check 12 on the inner surface 18b of leaf 16b. The user will straighten and flatten any folds or tears in the check 12. The user folds the leaf 16a along the means 22 for bending so that leaf 16a is aligned with leaf 16b. The check 12 is thereby enfolded between leaves 16a,b on the inner surfaces 18a,b of leaves 16a,b. The check 12, even if damaged, is flat and firmly held in place adjacent the alignment marks 42a,b for processing data and information may be applied and/or printed directly on the outer surfaces 20a,b of carrier 10 and read by a digital imaging machine through which the carrier 10 passes.

The carrier 10 for capturing digital images concurrently from both sides of a document 12 shown in drawing FIGS. 1A through 6B illustrates more than one embodiment that are not intended to be exclusive, but merely illustrative of the disclosed but non-exclusive embodiments. Claim elements and steps in this document have been numbered and lettered solely as an aid in readability and understanding. Claim elements and steps have been numbered solely as an aid in readability and understanding. The numbering is not intended to, and should not be considered as intending to, indicate the ordering of elements and steps in the claims. Means-plus-function clauses in the claims are intended to cover the structures described as performing the recited function that include not only structural equivalents, but also equivalent structures.

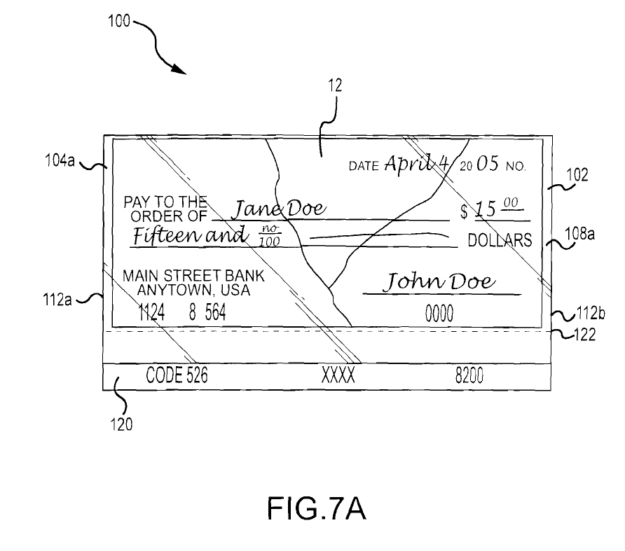

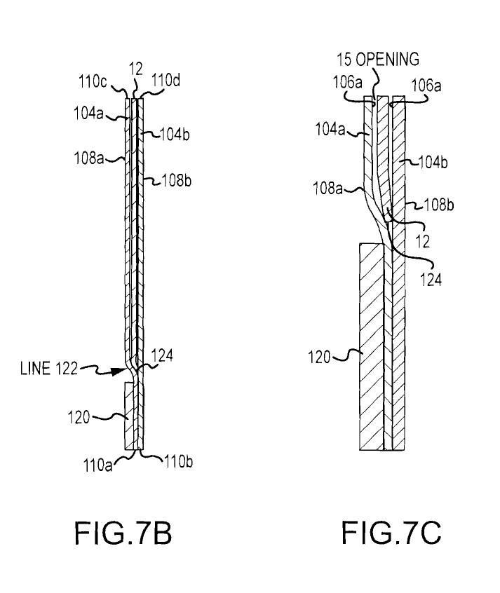

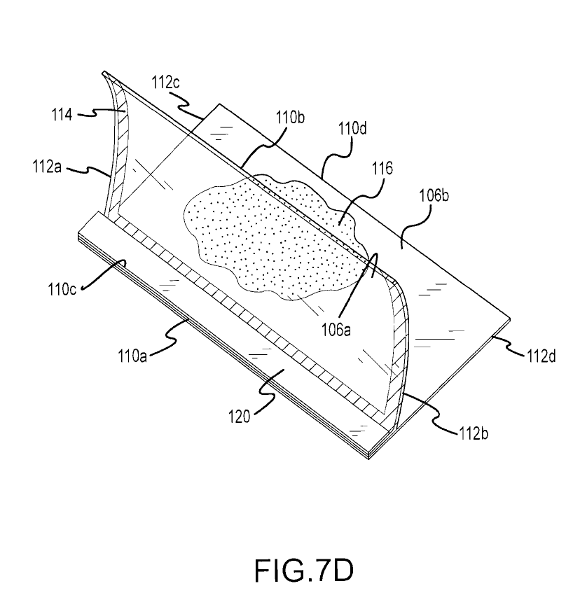

As shown by cross-reference between FIGS. 7A-7D, additional contributions to the art are shown and claimed in this document. The additional contributions provide additional optimizations and embodiments, and different principles of operation, differing configurations, and different structures and co-operation of structure as shown, illustrated and claimed in this document.

As shown by cross-reference between FIGS. 7A-7C, a sleeve 100 for capturing images of a check 12 is illustrated. As shown, the sleeve 100 is formed from a sheet of image transferable material 102. Preferably, the image transferable material also is anti-static. The sleeve 100 is cut or formed into at least two substantially identically dimensioned and substantially rectangular leaves 104a,b. Each leaf 104a,b has an inner surface 106a,b, an outer surface 108a,b, opposing longitudinal edges 110a-d, and opposing lateral edges 112a,b. An appropriate adhesive 14 is applied to at least one inner surface 106a,b of the at least two leaves 104a,b adjacent two opposing lateral edges 112a,b and adjacent one of the opposing longitudinal edges 110a, to fixedly connect the at least two leaves 104a,b into the sleeve 100 formed with an opening 115 through which a check 12 may be inserted into the sleeve 100. In addition, a representation-passable coating 116 is applied to the outer surface 108b of the back leaf 104b to enable printing of endorsement information 118 that may be read by an imaging machine (not shown). Representation-passable coating 116 is shown in FIG. 7D diagrammatically in an irregular substantially oval shape. However, it should be understood that representation-passable coating 116 is applied substantially to the entire outer surface 108b, and that the shape as illustrated in FIG. 7D is for illustrative purposes only, and is not a limitation of the sleeve 100 for capturing images of a check 12.

A strip of material 120, commonly referred to as a “correction strip,” generally in the shape of an elongated indicia-receiving strip as illustrated by cross-reference between FIGS. 7A-7D, which is formed separately from the front leaf 104a and the back leaf 014b, is adhesively secured directly to the sleeve 100 adjacent the bottom longitudinal edge 110a of front leaf 104a.

The adhesive used to adhesively secure the correction strip 120 to front leaf 104a is not shown diagrammatically, and is not a material limitation of sleeve 100. The correction strip is useful for providing a surface on which MICR and other information may be printed and read by an imaging machine during passage of the sleeve 100 containing the check 12 through the imaging machine. Another technical advantage of the correction strip 120 is that the correction strip 120 is dimensioned to enable a plurality sleeves 100 to be stacked substantially evenly on top of one another during shipment to a user and until deployed for passage through an imaging machine.

As illustrated by cross-reference between FIGS. 7A-7D, the generally rectangular planar back leaf 104b and the generally rectangular planar front leaf 104a are adhesively joined directly to each other along the lateral edges 112a-d and along a line 122. Line 122 is spaced from the bottom longitudinal edges 110a and 110b, as perhaps best illustrated by the arrow in FIG. 7B marking the general location of the line 122. As shown, line 122 is spaced from the bottom longitudinal edges 110a and 110b. At least one technical advantage is achieved by applying the appropriate adhesive 114 along line 122, which is to allow the lower edge 124 of check 12 to be carried by the sleeve 100, as perhaps best shown by cross-reference between FIGS. 7B-7C, and to be supported a predetermined distance from the bottom longitudinal edges 110a,b of the sleeve 100 during passage of sleeve 100 through an imaging machine.

As indicated, in one aspect of the sleeve 100 for capturing images when processed through an imaging machine (not shown) includes the appropriate adhesive 114 to connect the leaves 104a,b formed from the image transferable material 102 to form a pouch into which a check 12 may be placed for processing through an imaging machine to securely hold a damaged or undamaged check in place during transit through the imaging machine. At least one technical advantage of a water-based adhesive is its capability to connect plastic-to-plastic leaves 104a,b made from the image transferable material 102. Water-based adhesives include compounds that can be dissolved or dispersed in water. These adhesives generally develop a bond by losing water through evaporation or penetration into the substrates. At least one substrate must be absorbent or porous in order to form a strong bond. Water-based adhesives come in a variety of chemistries and compositions, and can be categorized as either natural or synthetic polymers.

A water-based adhesive is not a limitation of the sleeve 100 for capturing images, but is but one adhesive appropriate for use because of the properties of such an adhesive. Water-based adhesive are made from both natural and synthetic polymers. Such adhesive include polyvinyl acetate “PVAc”, a synthetic polymer and a member of the vinyl ester family; PVAc homopolymers, hard and brittle, with high molecular weight, high tensile strength and rapid speed of set. Other “water based” adhesives include vinyl acetate copolymer emulsions (“VAE, VAA”) because they offer the advantage of being able to bond difficult-to-bond substrates such as plastics, coated papers, and metal surfaces; acrylics available as emulsions and dispersions as well as liquids containing 100% polymer, because of their use as a multipurpose adhesive; polyurethane a synthetic polymer derived from isocyanate reactions; polychloroprene, because it is an extremely versatile synthetic elastomer that offers a unique combination of adhesive properties. Polychloroprene-based adhesives provide outstanding toughness, chemical resistance, weathering resistance, heat resistance, oil and chemical resistance, as well as very rapid bond strength development.

Also, the image transferable material is preferably an anti-static plastic that provides the technical advantage of avoiding material-induced and/or machine-induced “static” electrical problems that might arise during passage of the sleeve through the image-reading machines including a digital imaging machine. Conductive thermoplastic compounds offer reliability and value for applications that require dissipation of static and/or protection from electrostatic discharge (“ESD”). Multiple technologies are available to impart conductive properties to thermoplastic resins. Each offers different approaches to providing the exact degree of conductivity required for an application, whether anti-static, static dissipative, ESD protection, conductive, or EMI/RFI shielding.

Electrostatics (also known as static electricity) is a branch of physics that deals with the phenomena arising from what seem to be stationary electric charges. This includes phenomena as simple as the attraction of plastic wrap to a hand after removal from a package to apparently spontaneous explosion of grain silos, to damage of electronic components during manufacturing, to the operation of photocopiers. Electrostatics involves the buildup of charge on the surface of objects due to contact with other surfaces, such as the outer surfaces 108a,b of sleeve 100 as the sleeve 100 passes through an imaging machine, particularly at high speed. Although charge exchanges happens whenever any two surfaces contact and separate, the effects of charge exchanges are usually only noticed when at least one surface has a high resistance to electrical flow. This is because the charges that transfer to or from the highly resistive surface are more or less trapped there for a long enough time for their effects to be observed. These charges then remain on the object until they either bleed off to a ground or are quickly neutralized by a discharge, such as the familiar phenomenon of a static “shock” is caused by neutralization of charge built up in the body from contact with nonconductive surfaces.

Claim elements and steps in this document have been numbered solely as an aid in understanding the description. The numbering is not intended to, and should not be considered as intending to, indicate the ordering of elements and steps in the claims. In addition, a sleeve for capturing check images and check-related images shown in drawing FIGS. 7A through 7C shows at least one aspect of the a sleeve for capturing check images and check-related images, not intended to be exclusive, but merely illustrative of the disclosed embodiments. Of course, method steps may be interchanged sequentially without departing from the scope of the claims.

Means-plus-function clauses in the claims are intended to cover the structures described as performing the recited function that include not only structural equivalents, but also equivalent structures.

What is claimed is:

1. A sleeve for capturing images when processed through an imaging machine, comprising:
a sheet of anti-static image transferable material adapted to transfer an image of the check to an imaging machine,
wherein at least two leaves are formed from the sheet of image transferable material, each leaf having an inner surface, an outer surface, opposing longitudinal edges, and opposing lateral edges dimensionally less than the opposing longitudinal edges;
an appropriate adhesive applied to at least one inner surface of the at least two leaves adjacent the two opposing lateral edges and adjacent one of the opposing longitudinal edges adapted to fixedly connect the at least two leaves to form the sleeve having an opening defined by two opposing longitudinal edges for insertion of a check into the sleeve;
a representation-passable coating applied to at least one outer surface of one of the at least two leaves adapted to allow the imaging machine to read and record information printed on the sleeve and on the check; and
a correction strip attachable adjacent the longitudinal edge of one of the at least two leaves adapted to receive printed information readable and recordable by the imaging machine.

2. A sleeve for capturing images when processed through an imaging machine as recited in claim 1, wherein at least one outer surface of at least one leaf is coated to accept ink endorsements.

3. A sleeve for capturing images when processed through an imaging machine as recited in claim 1, wherein the sheet of image transferable material is a plastic.

4. A sleeve for capturing images when processed through an imaging machine as recited in claim 1, wherein the sheet of image transferable material is translucent.

5. A sleeve for capturing images when processed through an imaging machine as recited in claim 1, wherein at least the outer surface of at least two of the two leaves is coated to enable printing of an endorsement on the outer surface of the sleeve.

6. A sleeve for capturing images when processed through an imaging machine as recited in claim 1, wherein the sheet of image transferable material is sufficiently rigid to avoid aberrations in images.

7. A sleeve for capturing images when processed through an imaging machine as recited in claim 1, wherein the correction strip is adapted for printing encoding information that an imaging machine may read during passage of the sleeve through the imaging machine.

8. A check sleeve for processing checks through automatic imaging machines, comprising:
a generally rectangular planar back leaf formed of substantially image transferable material for permitting imaging of a check carried by the sleeve having a top longitudinal edge, a bottom longitudinal edge, and opposing lateral edges, wherein the top longitudinal edge and the bottom longitudinal edge are longer than the opposing lateral edges,
wherein the image transferable material further is coated with a representation-passable coating material adapted to permit printing of endorsements on the back leaf;
a generally rectangular planar front leaf formed of substantially image transferable material for permitting imaging of a check carried by the sleeve,
wherein the generally rectangular planar back leaf and the generally rectangular planar front leaf are adhesively joined directly to each other along the lateral edges thereof and along a line spaced from said longitudinal edges, said line being spaced from the bottom longitudinal edges whereby the lower edge of a check carried by the sleeve will be supported a predetermined distance from the bottom longitudinal edges of the sleeve; and
an elongated indicia-receiving strip formed separately from the front leaf and the back leaf and adhesively secured directly to the sleeve adjacent the bottom longitudinal edge,
wherein the elongated indicia-receiving strip is dimensioned to enable a plurality of check-carrying sleeves to be stacked substantially evenly one on another.

9. A check sleeve for processing checks through automatic imaging machines document carrier of claim 8, wherein the image transferable material is substantially anti-static.

10. A check sleeve for processing checks through automatic imaging machines document carrier of claim 9, wherein elongated indicia-receiving strip is adapted to be printable with an ink.

11. A check sleeve for processing checks through automatic imaging machines document carrier of claim 10, wherein the back leave and the front leaf are adhesively joined directly to each other with a water-based adhesive.

12. A check sleeve for processing checks through automatic imaging machines document carrier of claim 10, wherein the back leave and the front leaf are adhesively joined directly to each other with an adhesive that is adapted to join directly a back leaf and a front leaf made of image transferable material.

13. A check sleeve for processing checks through automatic imaging machines document carrier of claim 10, wherein the adhesive joining of the back leaf and the front leaf forms a pouch in the sleeve into which the check may be inserted and held during passage through the imaging machine.

14. A method for recording images from a check, comprising:
providing an imaging machine;
selecting a check;
forming a sleeve through which images may be obtained when processed through the imaging machine; and
routing the sleeve containing the check through the imaging machine.

15. A method for recording images from a check as recited in claim 14, wherein the sleeve forming step includes the substeps of:
selecting image transferable material for forming the sleeve;
applying a representation-passable coating to one side of the image transferable material;
manipulating the material to form a back leaf,
further manipulating the material to form a front leaf, and
providing means for adhesively binding the back leaf and the front leaf to form the sleeve.

16. A method for recording images from a check as recited in claim 14, further comprising the step of selecting a representation-passable coating receptive to MICR printing.

17. A method for recording images from a check as recited in claim 16, further comprising the step of applying the representation-passable coating receptive to MICR printing to at least the back leaf of the sleeve.

18. A method for recording images from a check as recited in claim 17, further comprising the step of adhesively connecting a strip of material to the sleeve on which information may be printed and recorded by the imaging machine during passage of the sleeve through the imaging machine.

19. A method for recording images from a check as recited in claim 18, further comprising the step of adhesively connecting the front leaf to the back leaf with an appropriate adhesive.

20. A method for recording images from a check as recited in claim 16, wherein the step of selecting image transferable material for forming the sleeve includes the substep of selecting image transferable material that is anti-static.
